(19) United States
(12) Patent Application Publication
(10) Pub. No.: US 2021/0201344 A1
(43) Pub. Date: Jul. 1, 2021

(54) ELECTRONIC VALUE MANAGEMENT SYSTEM, ELECTRONIC VALUE MANAGEMENT METHOD AND PROGRAM

(71) Applicant: Rakuten, Inc., Tokyo (JP)

(72) Inventor: Bruno Andre CHARRON, Setagaya-ku, Tokyo (JP)

(21) Appl. No.: 17/059,199

(22) PCT Filed: Nov. 1, 2019
(86) PCT No.: PCT/JP2019/043105

§ 371 Date: Nov. 25, 2020

(30) Foreign Application Priority Data
Dec. 28, 2018 (JP) PCT/JP2018/048606

(51) Int. Cl. G06Q 30/02; G06Q 20/38; G06Q 40/04

(52) U.S. Cl. CPC G06Q 30/0227; G06Q 20/0655; G06Q 40/04; G06Q 20/381

(57) ABSTRACT

To simplify a system of using an electronic value, which can be used across a plurality of countries or regions, provided is an electronic value management system configured to: acquire a first evaluated monetary amount based on a first currency, which is evaluated for a currently distributed electronic value issued for the first currency; acquire a second evaluated monetary amount based on a second currency, which is evaluated for a currently distributed electronic value issued for the second currency; and calculate an exchange rate between the first currency and the electronic value based on the first evaluated monetary amount, the second evaluated monetary amount, a foreign exchange rate between the first currency and the second currency, and a total amount of the currently distributed electronic value.

### TECHNICAL FIELD

The present invention relates to an electronic value management system, an electronic value management method, and a program.

### BACKGROUND ART

Loyalty points, virtual currency (also referred to as “cryptocurrency” or “crypto asset”), or the like, which is given a monetary value by some method, is often used for payment.

In Patent Literature 1, there is disclosed a technology involving defining, when a company owns assets across a plurality of countries, such a unique currency unit as to fix a total asset even when a foreign exchange rate has changed in any manner, and expressing a total asset value of that company by the unique currency.

### CITATION LIST

### Patent Literature

[PTL 1] JP 2001-195479 A

### SUMMARY OF INVENTION

### Technical Problem

Hitherto, there has been known a loyalty point system of giving loyalty points as benefits for, for example, purchase of a product. The given loyalty points can be used for, for example, purchase of other products. Now, there is assumed a system that enables usage of loyalty points given by a system of one country for payment in a system of another country. The value of loyalty points is associated with currency of a country that issues those loyalty points. Then, in this system, the value of given loyalty points is required to be converted to a value associated with currency of a country in which payment is made. There is a concern for a problem in that the system becomes more complex due to such conversion, and a large amount of computer resources are consumed, for example.

Meanwhile, virtual currency is assumed to be used across countries. However, also when virtual currency is used for shopping, for example, the virtual currency and normal currency are exchanged in a market system in which virtual currency and real currency are exchanged. There is a concern for a problem in that the system becomes more complex, and a large amount of computer resources are consumed also when exchange transaction is processed by using the market system.

The present invention has been made in view of the above-mentioned problem, and has an object to simplify a system of using an electronic value, which can be used across a plurality of countries (or regions), to thereby reduce consumption of computer resources, for example.

### Solution to Problem

In order to solve the above-mentioned problem, according to one embodiment of the present invention, there is provided an electronic value management system including: first acquisition means for acquiring a first evaluated monetary amount based on a first currency, which is evaluated for a currently distributed electronic value issued for the first currency; second acquisition means for acquiring a second evaluated monetary amount based on a second currency, which is evaluated for a currently distributed electronic value issued for the second currency; and rate calculation means for calculating an exchange rate between the first currency and the electronic value based on the first evaluated monetary amount, the second evaluated monetary amount, a foreign exchange rate between the first currency and the second currency, and a total amount of the currently distributed electronic value.

Further, according to one embodiment of the present invention, there is provided an electronic value management method including the steps of: acquiring a first evaluated monetary amount based on a first currency, which is evaluated for a currently distributed electronic value issued for the first currency; acquiring a second evaluated monetary amount based on a second currency, which is evaluated for a currently distributed electronic value issued for the second currency; and calculating an exchange rate between the first currency and the electronic value based on the first evaluated monetary amount, the second evaluated monetary amount, a foreign exchange rate between the first currency and the second currency, and a total amount of the currently distributed electronic value.

Further, according to one embodiment of the present invention, there is provided a program for causing a computer to function as: first acquisition means for acquiring a first evaluated monetary amount based on a first currency, which is evaluated for a currently distributed electronic value issued for the first currency; second acquisition means for acquiring a second evaluated monetary amount based on a second currency, which is evaluated for a currently distributed electronic value issued for the second currency; and rate calculation means for calculating an exchange rate between the first currency and the electronic value based on the first evaluated monetary amount, the second evaluated monetary amount, a foreign exchange rate between the first currency and the second currency, and a total amount of the currently distributed electronic value.

According to the present invention, it is possible to provide an electronic value that can be used internationally and has a monetary value unlikely to fluctuate drastically at the time of exchange for real currency.

According to one aspect of the present invention, the electronic value management system may further include conversion means for converting the second evaluated monetary amount to the first currency based on the foreign exchange rate between the first currency and the second currency. The rate calculation means may be configured to calculate the exchange rate between the first currency and the electronic value based on the first evaluated monetary amount, the converted second evaluated monetary amount, and the total amount of currently distributed electronic value.

According to one aspect of the present invention, the electronic value management system may further include total evaluation means for calculating a total evaluated monetary amount based on the first evaluated monetary amount and the converted second evaluated monetary amount. The rate calculation means may be configured to calculate the exchange rate between the first currency and the electronic value by dividing the total evaluated monetary amount by the total amount of currently distributed electronic value.

According to one aspect of the present invention, the first evaluated monetary amount may be an allowance saved by the first currency depending on an electronic value issued for the first currency, and the second evaluated monetary amount may be an allowance saved by the second currency depending on an electronic value issued for the second currency.

According to one aspect of the present invention, the electronic value management system may further include first currency exchange means for exchanging, based on the calculated exchange rate, an electronic value having a given recorded amount for the first currency having a currency amount equivalent to the electronic value.

According to one aspect of the present invention, the electronic value management system may further include second currency exchange means for exchanging, based on the calculated exchange rate, an electronic value having a given recorded amount for the second currency having a currency amount equivalent to the electronic value.

According to one aspect of the present invention, the electronic value management system may further include: first currency exchange means for providing, for the first currency having a given first currency amount, an electronic value having a first recorded amount that depends on the given first currency amount and the exchange rate, and providing, for an electronic value having a given second recorded amount, the first currency having a second currency amount that depends on the given second recorded amount and the exchange rate; second currency exchange means for providing, for the second currency having a given third currency amount, an electronic value having a third recorded amount that depends on the given third currency amount and the exchange rate, and providing, for an electronic value having a given fourth recorded amount, the first currency having a fourth currency amount that depends on the given fourth recorded amount and the exchange rate; first allowance management means for adding, when the electronic value is provided for the first currency, a value equivalent to the given first currency amount to a first allowance being an allowance based on the first currency, and subtracting, when the first currency is provided for the electronic value, a value equivalent to the second currency amount from the first allowance; and second allowance management means for adding, when the electronic value is provided for the second currency, a value equivalent to the given third currency amount to a second allowance being an allowance based on the second currency, and subtracting, when the second currency is provided for the electronic value, a value equivalent to the fourth currency amount from the second allowance.

### BRIEF DESCRIPTION OF DRAWINGS

FIG. 1 is a diagram for illustrating a relationship between a virtual currency management system and another system in one embodiment of the present invention.

FIG. 2 is a diagram for illustrating an example of a hardware configuration of a virtual currency management system.

FIG. 3 is a sequence diagram for illustrating a flow of issuing a virtual coin.

FIG. 4 is a sequence diagram for illustrating a flow of payment using a virtual coin.

FIG. 5 is a flow chart for illustrating an example of processing to be executed by an electronic commerce system.

FIG. 6 is a block diagram for illustrating functions to be implemented by the virtual currency management system.

FIG. 7 is a flow chart for illustrating an example of processing to be executed by the virtual currency management system in response to a virtual coin issuance request.

FIG. 8 is a flow chart for illustrating an example of processing to be executed by the virtual currency management system in response to a currency exchange request.

FIG. 9 is a flow chart for illustrating an example of processing of calculating an exchange rate.

FIG. 10 is a table for showing an example of virtual coin ownership information.

FIG. 11 is a diagram for illustrating an example of a screen for payment method display.

FIG. 12 is a flow chart for illustrating another example of the processing to be executed by the electronic commerce system.

### DESCRIPTION OF EMBODIMENTS

Now, description is made of one embodiment of the present invention with reference to the drawings. A redundant description of a component denoted by the same reference symbol is omitted. In this embodiment, an example of using virtual currency (virtual currency issued in this embodiment is referred to as “virtual coin”) as an electronic value is described. The virtual currency in this embodiment refers to information that is distributed as having an electronic value, is not backed up by a specific country, and does not have mandatory circulating power as legal tender. A plurality of systems are configured to manage, for example, an owner of the electronic value of virtual currency in a distributed manner. The present invention can also be applied to a loyalty point system for centrally managing, for example, an owner in one system. In the loyalty point system, an electronic value is a loyalty point given as benefits for purchase, for example.

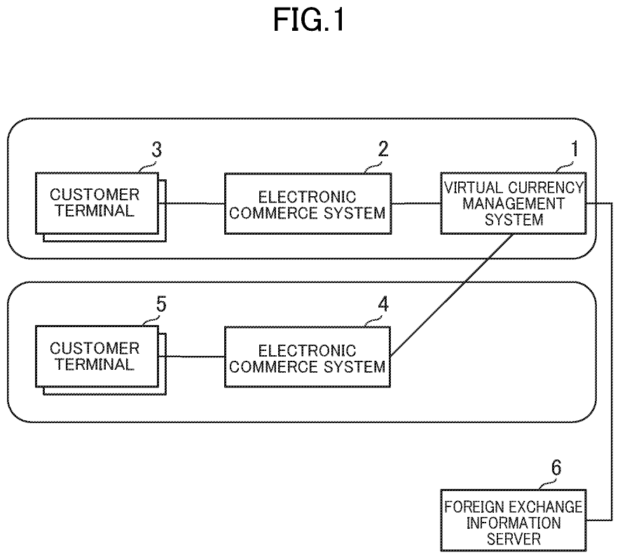

FIG. 1 is a diagram for illustrating a relationship between a virtual currency management system 1 and another system in one embodiment of the present invention. The virtual currency management system 1, an electronic commerce system 2, and a customer terminal 3 are present in a country or region (e.g., Japan) having a first currency (hereinafter, Japanese yen) as legal tender, and the first currency is used for payment of a monetary value, for example. An electronic commerce system 4 and a customer terminal 5 are present in a country or region (e.g., the United States of America) having a second currency (hereinafter, US dollar) as legal tender, and the second currency is used for payment, for example. The virtual currency management system 1 and the electronic commerce systems 2 and 4 are configured to communicate to/from each other via a network, for example, the Internet, and the electronic commerce systems 2 and 4 and the customer terminals 3 and 5 are configured to communicate to/from each other, respectively.

The respective electronic commerce systems 2 and 4 present, to the customer terminals 3 and 5, a product or service sold by a plurality of shops, and receive orders thereof from the customer terminals 3 and 5. Specifically, the customer terminals 3 and 5 are computers to be operated by a user being a customer.

A foreign exchange information server 6 is a server configured to provide a foreign exchange rate between the first currency and the second currency, which has been determined by a foreign exchange market. The foreign exchange information server 6 may be a system configured to manage a current foreign exchange rate, or may be a system configured to simply disclose the current foreign exchange rate.

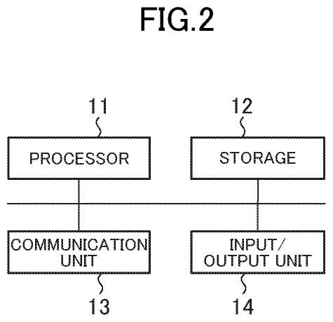

The virtual currency management system 1 is a system configured to exchange a monetary value based on currency (e.g., Japanese yen) fora virtual coin, and manage issuance of the virtual coin. FIG. 2 is a diagram for illustrating an example of a hardware configuration of the virtual currency management system 1, and is an example of a case in which the virtual currency management system 1 is constructed by one server computer. The virtual currency management system 1 includes a processor 11, a storage 12, a communication unit 13, and an input/output unit 14. The virtual currency management system 1 may be implemented by a plurality of server computers.

The processor 11 is configured to operate in accordance with a program stored in the storage 12. Further, the processor 11 is configured to control the communication unit 13 and the input/output unit 14. The above-mentioned program may be provided via, for example, the Internet, or may be stored in a storage medium capable of being read by a computer, such as a flash memory or a DVD-ROM, for provision.

The storage 12 is constructed by a memory device, such as a RAM and a flash memory, and an external device, for example, a hard disk drive. The storage 12 stores the above-mentioned program. Further, the storage 12 stores information input from each component and calculation results.

The communication unit 13 implements a function of communicating to/from other devices, and is constructed by an integrated circuit of a wired LAN, for example. The communication unit 13 is configured to input information received from other devices to the processor 11 or the storage 12 based on control by the processor 11, and transmit the information to the other devices.

The input/output unit 14 is constructed by, for example, a video controller configured to control a display output device or a controller configured to acquire data from an input device. The input device includes, for example, a keyboard, a mouse, or a touch panel. The input/output unit 14 is configured to output display data to the display output device based on control by the processor 11, and acquire data input by the user operating the input device. The display output device is, for example, a display device connected externally, for example.

Similarly to the virtual currency management system 1, a server computer included in each of the electronic commerce systems 2 and 4 includes the processor 11, the storage 12, the communication unit 13, and the input/output unit 14.

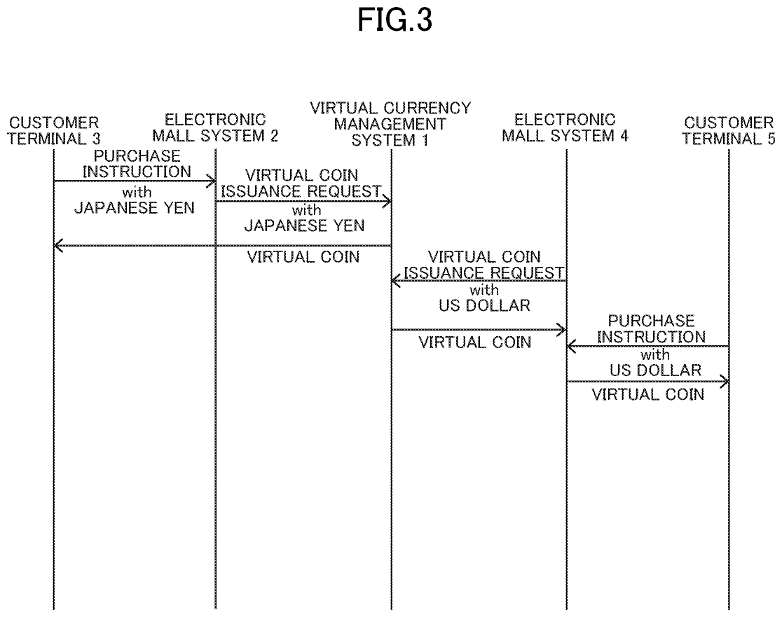

Now, description is made of processing involving issuing a virtual coin, which is executed by the virtual currency management system 1, the electronic commerce systems 2 and 4, and the customer terminals 3 and 5. FIG. 3 is a sequence diagram for illustrating a flow of issuing a virtual coin.

First, description is made of a flow of processing relating to the first currency. When the customer purchases a desired product by using the customer terminal 3 in the electronic commerce system 2, the customer terminal 3 transmits data (purchase instruction) for specifying purchase of, for example, a product by Japanese yen to the electronic commerce system 2. Then, the electronic commerce system 2 receives an order of the purchase, and determines a monetary value in Japanese Yen as benefits to be provided to the customer for the order. In practice, the customer terminal 3 and the electronic commerce system 2 exchange pieces of data such as a purchase procedure instruction, payment method display, a payment method instruction, and confirmation display before the transmission of the purchase instruction. Details of those pieces of data are described later. Further, the monetary value of benefits is calculated by multiplying a payment amount for purchase of, for example, a product by a predetermined rate (e.g., 1%). For example, when the customer operating the customer terminal 3 has purchased a product of 10,000 yen, the monetary value of benefits is determined to be 100 yen.

When the benefits are determined, the electronic commerce system 2 transmits a virtual coin issuance request to the virtual currency management system 1. This virtual coin issuance request is data for requesting to issue a virtual coin equivalent to the calculated monetary value. The virtual currency management system 1 sets the customer operating the customer terminal 3 as an owner of the virtual coin equivalent to the calculated monetary value based on a first exchange rate. More specifically, the owner of the virtual coin is set by updating the virtual coin ownership information of the virtual currency management system 1. The virtual currency management system 1 reserves, by mining in advance, a virtual coin for which the owner is set.

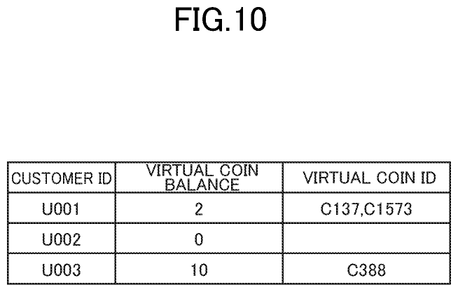

The virtual coin ownership information is stored in the storage 12 of the virtual currency management system 1. FIG. 10 is a table for showing an example of the virtual coin ownership information. The virtual coin ownership information stores a balance of a virtual coin owned by a customer and information (virtual coin ID) for identifying the virtual coin owned by the customer in association with information (customer ID) for identifying the customer. When a certain amount of virtual coin is provided to a customer, the virtual currency management system 1 increases the balance of the virtual coin associated with a customer ID of the customer by that amount to be provided, and stores a virtual coin ID of the virtual coin to be provided in association with the customer ID. The virtual coin ownership information may simply be information for associating the virtual coin ID with the customer ID, or may be managed by other systems or terminals, for example.

The virtual currency management system 1 issues a virtual coin to the market (customer) and distributes the virtual coin to the market by setting the owner of the virtual coin. This virtual coin may be generated by mining in advance. The first exchange rate is an exchange rate in a case where the first currency and the virtual coin are exchanged with each other, and changes depending on the situation. Further, the virtual currency management system 1 transmits data on the issued virtual coin to the customer terminal 3. The data on the issued virtual coin may be transmitted to the customer terminal 3 via the electronic commerce system 2.

Next, description is made of a flow of processing relating to the second currency. In the case of the second currency, the electronic commerce system 4 transmits a virtual coin issuance request to the virtual currency management system 1 before the customer terminal 5 performs an operation relating to purchase. This virtual coin issuance request is data for the electronic commerce system 4 to request the virtual currency management system 1 to issue a virtual coin corresponding to US dollar. In the case of the second currency, the electronic commerce system 4 requests the virtual currency management system 1 to issue a virtual coin that depends on US dollar owned by the electronic commerce system 4 in advance. The virtual currency management system 1 issues a virtual coin equivalent to the monetary value of the US dollar based on a second exchange rate, and transmits the issued virtual coin to the electronic commerce system 4. The electronic commerce system 4 pools the issued and transmitted virtual coin. The second exchange rate is an exchange rate in a case where the second currency and the virtual coin are exchanged, and changes depending on the situation.

Then, when the customer terminal 5 has transmitted data (purchase instruction) for transmitting an instruction to purchase, for example, a product by US dollar, the electronic commerce system 4 passes, among pooled virtual coins, a virtual coin equivalent to the benefits that depend on that purchase to the customer operating the customer terminal 5. More specifically, the electronic commerce system 4 sets the customer operating the customer terminal 5 as an owner of the virtual coin. Similarly to the flow of processing in Japanese Yen, pieces of data such as a purchase procedure instruction, payment method display, a payment method instruction, and confirmation display are exchanged between the customer terminal 5 and the electronic commerce system 4 before the transmission of the purchase instruction. The monetary value of benefits is calculated by multiplying a payment amount for purchase of, for example, a product by a predetermined rate (e.g., 1%). For example, when the customer operating the customer terminal 5 has purchased a product of 100 dollars, the monetary value of benefits is determined to be 1 dollar, and the electronic commerce system 4 determines the amount of virtual coins to be passed to the customer based on the determined monetary value and an internal exchange rate for US dollar set for the pooled virtual coins, and provides the equivalent amount of virtual coin to the customer.

When there are three or more types of currency, processing similar to that for the second currency may be executed for currency different from the first currency. The same holds true below unless otherwise specified.

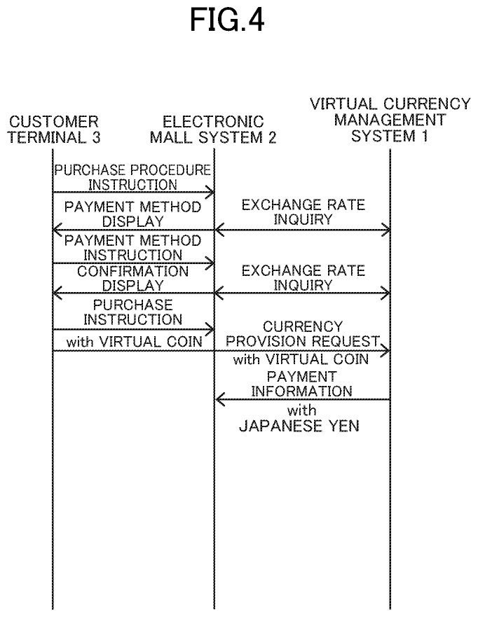

Now, regarding the first currency, description is made of a flow of processing involving payment using a virtual coin, which is executed by the virtual currency management system 1, the electronic commerce system 2, and the customer terminal 3. FIG. 4 is a sequence diagram for illustrating a flow of payment using a virtual coin.

First, the customer operates the customer terminal 3 to store a product to be purchased into a cart, and presses a button for proceeding with a procedure of purchase of a product or service stored in the cart. Then, the customer terminal 3 transmits, to the electronic commerce system 2, a purchase procedure instruction being an instruction to proceed with the procedure of purchase of the product or service. The electronic commerce system 2 continuously inquires the virtual currency management system 1 for the first exchange rate between the virtual currency and Japanese yen, and transmits data (payment method display) for specifying a method of paying the specified product or service to the customer terminal 3. In the payment method display, the electronic commerce system 2 transmits the first exchange rate separately in real time. When an available virtual coin is displayed, the electronic commerce system 2 acquires, from the virtual currency management system 1, for example, the balance of the virtual coin from the virtual coin ownership information for that customer, repeatedly calculates the monetary value of the available virtual coin based on the balance and exchange rate, and repeatedly transmits data on the monetary value (e.g., converted amount in Japanese Yen) to the customer terminal 3.

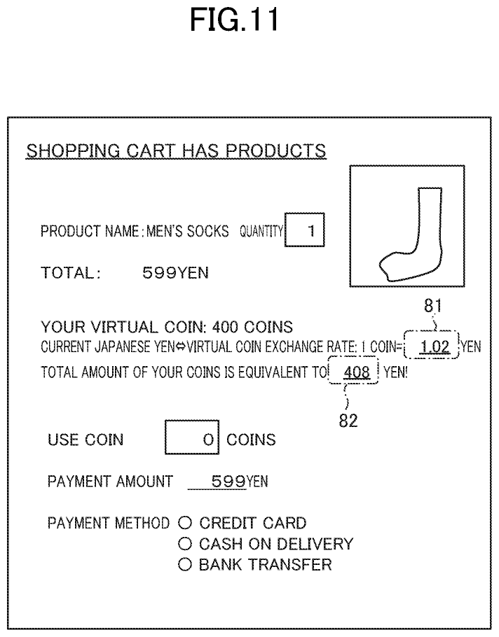

FIG. 11 is a diagram for illustrating an example of a screen for payment method display. For example, when the customer terminal 3 has received the first exchange rate and an amount obtained by converting the virtual coin held by the customer to the first currency, the customer terminal 3 repeatedly updates in real time a first exchange rate 81 displayed on the screen for payment method display and the available monetary value (converted amount 82 in Japanese Yen) of the virtual coin. Only one of the first exchange rate 81 and the converted amount 82 may be displayed.

When the customer terminal 3 has transmitted the data (payment method instruction) for specifying the payment method, the electronic commerce system 2 transmits, to the customer terminal 3, data (confirmation display) for displaying a screen for confirming, for example, the ordered product and payment method. Also in the confirmation display, the electronic commerce system 2 transmits in real time the first exchange rate and the amount of evaluation of the virtual coin held by the customer, and the customer terminal 3 updates in real time the first exchange rate or the monetary value of the virtual coin to be used for payment, which is displayed on the screen.

When the user has performed an operation on the screen for confirmation display, the customer terminal 3 transmits a purchase instruction and a virtual coin to be used for payment. When the electronic commerce system 2 has received the purchase instruction and the virtual coin, the electronic commerce system. 2 transmits a currency provision request to the virtual currency management system 1. The currency provision request is data for requesting the virtual currency management system 1 to return a virtual coin to the virtual currency management system, and provide currency of the monetary value equivalent to the virtual coin. When the virtual currency management system 1 has received the currency provision request, the virtual currency management system 1 transmits, to the electronic commerce system 2, information (payment information) to the effect that Japanese yen equivalent to the virtual coin is paid to the electronic commerce system 2. When the electronic commerce system 2 has received the payment information, the electronic commerce system 2 executes payment processing relating to the order of the product.

It is to be understood that payment may be a combination of the virtual coin and other payment methods (e.g., credit card). In the example of FIG. 4, a virtual coin serving as benefits is not issued, but the virtual coin may further be issued.

Regarding the second currency, when the customer uses a virtual coin for payment, the electronic commerce system 4 receives payment as a monetary value that depends on an internal exchange rate, and pools the virtual coin. When the amount of virtual coin pooled in the electronic commerce system 4 exceeds an appropriate range, the electronic commerce system 4 transmits a currency provision request to the virtual currency management system 1, exchanges a part of the virtual coin for US dollar based on the second exchange rate, and updates the internal exchange rate based on the second exchange rate. This processing may be executed not only when the amount of virtual coin exceeds the appropriate range, but also in accordance with a schedule determined in advance. For example, this processing may be executed every week or at a fixed time every day.

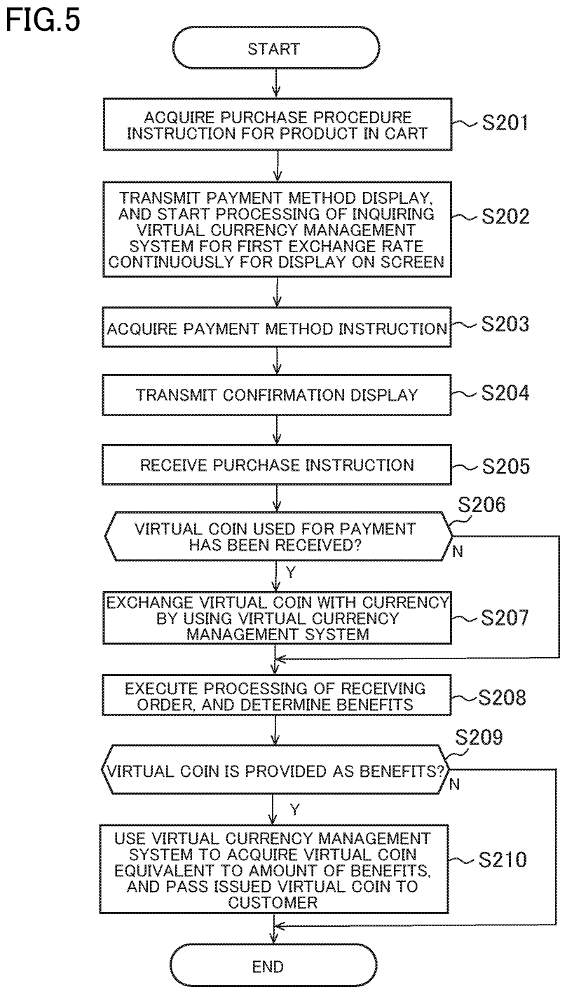

Now, the processing relating to purchase in the electronic commerce system 2 is described more in detail. FIG. 5 is a flow chart for illustrating an example of processing to be executed by the electronic commerce system 2. FIG. 5 is an illustration of processing since a purchase procedure instruction relating to an order is received from the customer terminal 3 and reception of the order is executed after that until a virtual coin is provided as required. The processing illustrated in FIG. 5 is executed by the processor 11 included in the electronic commerce system 2 executing a program stored in the storage 12 to control the communication unit 13, for example. The processing illustrated in FIG. 5 is executed in both of a case in which a virtual coin is issued and a case in which payment is made by using a virtual coin.

First, the processor 11 included in the electronic commerce system 2 acquires a purchase procedure instruction for a product in the cart, which has been received by the communication unit 13 (Step S201). Then, the processor 11 causes the communication unit 13 to transmit, to the customer terminal 3, data (payment method display) for displaying a screen for specifying a payment method, and starts to execute exchange rate update processing (Step S202). The exchange rate update processing is processing of transmitting, to the customer terminal 3, the latest first exchange rate acquired by inquiring the virtual currency management system 1 for the first exchange rate periodically and continuously, and displaying the latest first exchange rate on the screen of the customer terminal 3. The processor 11 executes the exchange rate update processing in parallel until reception of a purchase instruction.

Then, the processor 11 acquires the payment method instruction, which has been received by the communication unit 13 from the customer terminal 3 (Step S203). Then, the processor 11 causes the communication unit 13 to transmit, to the customer terminal 3, data (confirmation display) for displaying a screen for confirming, for example, a product to be ordered and the payment method (Step S204). Information (amount of payment by virtual coin and amount of payment by other payment methods) displayed on the screen of the customer terminal 3 is updated in real time based on the latest first exchange rate also in this stage.

The processor 11 acquires a purchase instruction, which has been received by the communication unit 13 from the customer terminal 3 (Step S205). The purchase instruction indicates the fact that the customer operating the customer terminal 3 has confirmed the product to be ordered and the payment method, which are displayed on the confirmation display, and also indicates an instruction to cause the electronic commerce system 4 to receive the order confirmed.

When the purchase instruction is acquired, the processor 11 checks whether data on the virtual coin to be used for payment has been received together with the purchase instruction (Step S206). When the data on the virtual coin has been received (Y in Step S206), the processor 11 causes the communication unit 13 to transmit a currency provision request to the virtual currency management system 1, and acquires payment information to exchange the virtual coin for the first currency (Step S207). Then, the processing transitions to Step S208. On the contrary, when the data on the virtual coin has not been received (N in Step S206), the processor 11 skips the processing of Step S207.

In Step S208, the processor 11 executes payment processing and processing of receiving an order based on, for example, the payment method included in the confirmation display, and determines benefits to be provided to the customer operating the customer terminal 3 for that order (Step S208).

Then, when it is determined that a virtual coin is provided to the customer as benefits (Y in Step S209), the processor 11 causes the communication unit 13 to transmit a virtual coin issuance request to the virtual currency management system 1, acquires, from the virtual currency management system 1, data on a virtual coin equivalent to the monetary amount of benefits via the communication unit 13, and passes the acquired data on the virtual coin to the customer terminal 3 (Step S210). When it is determined that the virtual coin is not provided to the customer as benefits (N in Step S209), the processing of Step S210 is skipped.

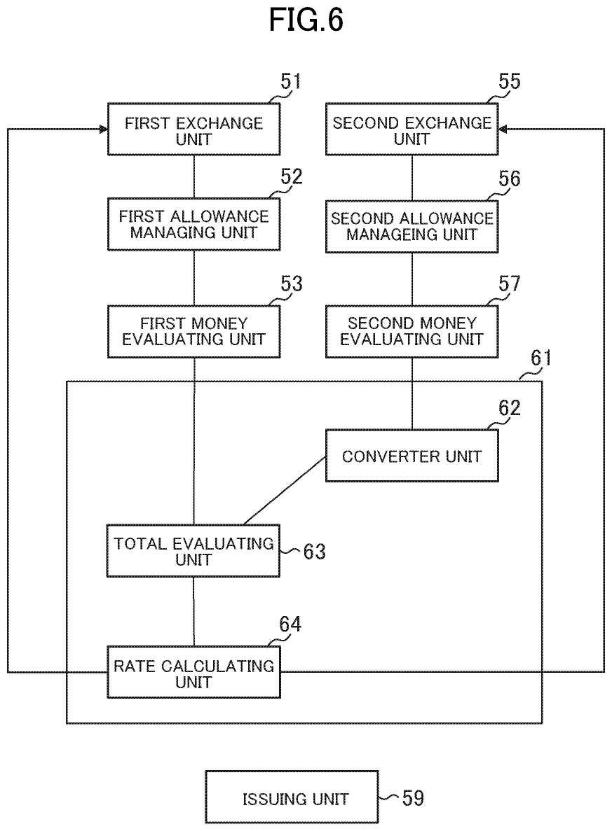

Next, description is made of functions and processing to be implemented by the virtual currency management system 1 in one embodiment of the present invention. FIG. 6 is a block diagram for illustrating functions to be implemented by the virtual currency management system 1. From the functional point of view, the virtual currency management system 1 includes a first exchange unit 51, a first allowance managing unit 52, a first money evaluating unit 53, a second exchange unit 55, a second allowance managing unit 56, a second money evaluating unit 57, an issuing unit 59, and a rate managing unit 61. Further, from the functional point of view, the rate managing unit 61 includes a converter unit 62, a total evaluating unit 63, and a rate calculating unit 64. Those functions are implemented by the processor 11 included in the virtual currency management system 1 executing programs stored in the storage 12 and controlling, for example, the communication unit 13.

The first exchange unit 51 is mainly implemented by the processor 11 executing a program stored in the storage 12 and controlling the communication unit 13. The first exchange unit 51 provides, based on the first currency equivalent to benefits for the customer and provided from the electronic commerce system 2, an amount (hereinafter referred to as “recorded amount”) of virtual coin that depends on the amount (hereinafter referred to as “currency amount”) of the first currency and the first exchange rate. Further, the first exchange unit 51 provides the customer with the currency amount of the first currency that depends on the recorded amount of virtual coin, which the customer wishes to exchange, and the first exchange rate.

The first allowance managing unit 52 is mainly implemented by the processor 11 executing a program stored in the storage 12. When the first exchange unit 51 has provided the recorded amount of virtual coin in accordance with the currency amount of the first currency, the first allowance managing unit 52 adds the currency amount to an amount of first allowance. When the first exchange unit 51 has provided the currency amount of the first currency based on the recorded amount of virtual coin, the first allowance managing unit 52 subtracts the currency amount from the amount of first allowance. The amount of first allowance is an amount of allowance for exchanging the currently distributed virtual coin for the first currency.

The second exchange unit 55 is mainly implemented by the processor 11 executing a program stored in the storage 12 and controlling the communication unit 13. The second exchange unit 55 provides, based on the second currency provided from the electronic commerce system 4, a recorded amount of virtual coin that depends on the currency amount of the second currency and the second exchange rate. Further, the second exchange unit 55 provides the currency amount of the second currency that depends on the recorded amount of virtual coin and the second exchange rate.

The second allowance managing unit 56 is mainly implemented by the processor 11 executing a program stored in the storage 12. When the second exchange unit 55 has provided the recorded amount of virtual coin in accordance with the currency amount of the first currency, the second allowance managing unit 56 adds the currency amount to an amount of second allowance. When the second exchange unit 55 has provided the currency amount of the first currency based on the recorded amount of virtual coin, the second allowance managing unit 56 subtracts the currency amount from the amount of second allowance. The amount of second allowance is an amount of allowance for exchanging the currently distributed virtual coin for the second currency.

The number of types of currency handled by the virtual currency management system 1 may be three or more. In this case, there may be provided a k-th exchange unit and a k-th allowance managing unit, where n represents an integer of 3 or more and k represents an integer of 3 or more and n or less. The k-th exchange unit is configured to exchange k-th currency for a virtual coin by processing similar to that of the second exchange unit 55. The k-th allowance managing unit is configured to manage an amount of k-th allowance for the k-th currency by processing similar to that of the second allowance managing unit 56.

The first money evaluating unit 53 and the second money evaluating unit 57 are mainly implemented by the processor 11 executing a program stored in the storage 12. The first money evaluating unit 53 is configured to acquire a first evaluated monetary amount of the first currency, which is evaluated for the currently distributed virtual coin issued for the first currency. The second money evaluating unit 57 is configured to acquire a first evaluated monetary amount of the second currency, which is evaluated for the currently distributed virtual coin issued for the second currency.

The issuing unit 59 is configured to acquire, through mining in advance, a virtual coin to be provided to, for example, a customer from the virtual currency management system 1, and pool the acquired virtual coin in the virtual currency management system 1.

In this embodiment, the first evaluated monetary amount is the same as the amount of first allowance, and the second evaluated monetary amount is the same as the amount of second allowance. When the processing of the rate managing unit 61 is started, the first money evaluating unit 53 acquires the amount of first allowance as the first evaluated monetary amount. When the processing of the rate managing unit 61 is started, the second money evaluating unit 57 acquires the amount of second allowance as the second evaluated monetary amount. When the number of types of currency handled by the virtual currency management system 1 is n, there may be provided a k-th money evaluating unit configured to execute similar processing for the k-th currency.

The converter unit 62 is mainly implemented by the processor 11 executing a program stored in the storage 12. The converter unit 62 is configured to convert the second evaluated monetary amount (amount of second allowance) to the first currency based on the foreign exchange rate between the first currency and the second currency, which is acquired from the foreign exchange information server 6. When the number of types of currency handled by the virtual currency management system 1 is n, the converter unit 62 may convert a k-th evaluated monetary amount (amount of k-th allowance) to the first currency based on a foreign exchange rate between the first currency and the k-th currency, which is acquired from the foreign exchange information server 6.

The total evaluating unit 63 is mainly implemented by the processor 11 executing a program stored in the storage 12. The total evaluating unit 63 is configured to calculate a total evaluated amount based on the first evaluated monetary amount and the converted second evaluated monetary amount. When the number of types of currency handled by the virtual currency management system 1 is n, the total evaluated amount may be calculated as a sum of the first evaluated monetary amount, the converted second evaluated monetary amount, and the converted k-th evaluated monetary amount.

The rate calculating unit 64 is mainly implemented by the processor 11 executing a program stored in the storage 12. The rate calculating unit 64 is configured to calculate the first exchange rate between the first currency and the virtual coin by dividing the total evaluated value by the total amount of currently distributed virtual coin. Further, the rate calculating unit 64 is configured to calculate the second exchange rate based on the calculated first exchange rate and the foreign exchange rate between the first currency and the second currency.

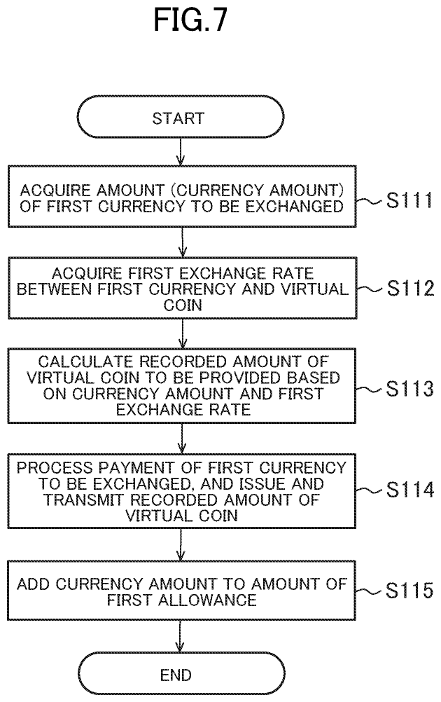

FIG. 7 is a flow chart for illustrating an example of processing to be executed by the virtual currency management system 1 in response to a virtual coin issuance request. FIG. 7 is an illustration of processing to be executed by the first exchange unit 51 and the first allowance managing unit 52 in a case where the first currency is exchanged for the virtual coin. However, the second exchange unit 55 and the second allowance managing unit 56 execute similar processing also for the second currency, and the same holds true for the k-th exchange unit and the k-th allowance managing unit.

First, the first exchange unit 51 acquires the currency amount of the first currency to be exchanged in response to a virtual coin issuance request (Step S111). Next, the first exchange unit 51 acquires the first exchange rate calculated by the rate calculating unit 64 described later (Step S112). The first exchange rate is an exchange rate between the first currency and the virtual coin as described above.

The first exchange unit 51 calculates the recorded amount of virtual coin to be provided based on the acquired currency amount and the acquired first exchange rate (Step S113). More specifically, when the first exchange rate indicates a currency amount of the first currency to be exchanged for a virtual coin whose recorded amount is 1, the first exchange unit 51 calculates a recorded amount of virtual coin to be provided by dividing the acquired currency amount by the first exchange rate.

When the recorded amount is calculated, the first exchange unit 51 processes payment of the first currency to be exchanged, issues a recorded amount of virtual coin, and transmits the issued virtual coin to the electronic commerce system 2 (Step S114). Then, the first allowance managing unit 52 adds the acquired currency amount to the amount of first allowance (Step S115). The first exchange unit 51 may issue a virtual coin equivalent to an amount obtained by subtracting a fee from the currency amount. In this case, the first allowance managing unit 52 may add a value obtained by subtracting the fee from the currency amount to the amount of first allowance.

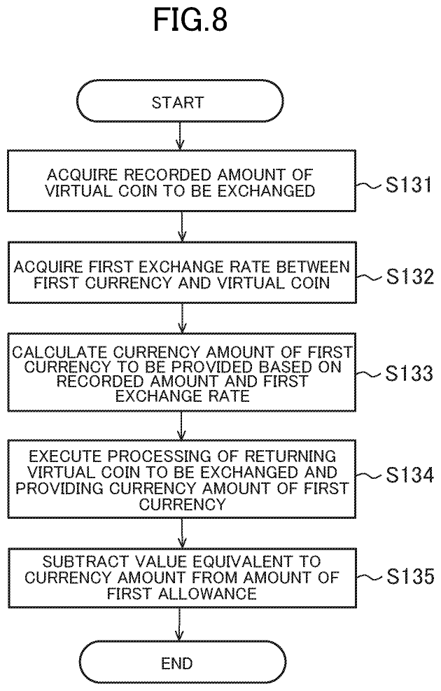

FIG. 8 is a flow chart for illustrating an example of processing to be executed by the virtual currency management system 1 in response to a currency provision request. FIG. 8 is an illustration of processing to be executed by the first exchange unit 51 and the first allowance managing unit 52 in a case where the virtual coin is exchanged for the first currency. However, the second exchange unit 55 and the second allowance managing unit 56 execute similar processing also for the second currency, and the same holds true for the k-th exchange unit and the k-th allowance managing unit.

First, the first exchange unit 51 acquires the recorded amount of virtual coin to be exchanged in response to a currency provision request (Step S131). Next, the first exchange unit acquires the first exchange rate calculated by the rate calculating unit 64 described later (Step S132).

The first exchange unit 51 calculates the currency amount of the first currency to be provided based on the acquired recorded amount and the acquired first exchange rate (Step S133). More specifically, when the first exchange rate indicates the currency amount of the first currency to be exchanged for the virtual coin whose recorded amount is 1, the first exchange unit 51 calculates the currency amount of the first currency to be provided by multiplying the acquired recorded amount by the first exchange rate.

When the currency amount is calculated, the first exchange unit 51 sets the owner of the virtual coin to be exchanged as the virtual currency management system 1, to thereby execute processing of returning the virtual coin and providing the calculated currency amount of the first currency (Step S134). Specifically, the first exchange unit 51 executes processing of acknowledging payment obligation from the virtual currency management system 1 to the electronic commerce system 2, and the virtual currency management system 1 executes processing of transmitting money in real time or at a predetermined date and time. Then, the first allowance managing unit 52 adds the acquired currency amount to the amount of first allowance (Step S115). The first exchange unit 51 may provide the first currency obtained by subtracting a fee from the currency amount.

In the examples of FIG. 7 and FIG. 8, the exchange rate may be a reciprocal. In this case, multiplication and division are exchanged with each other in Step S113 and Step S213.

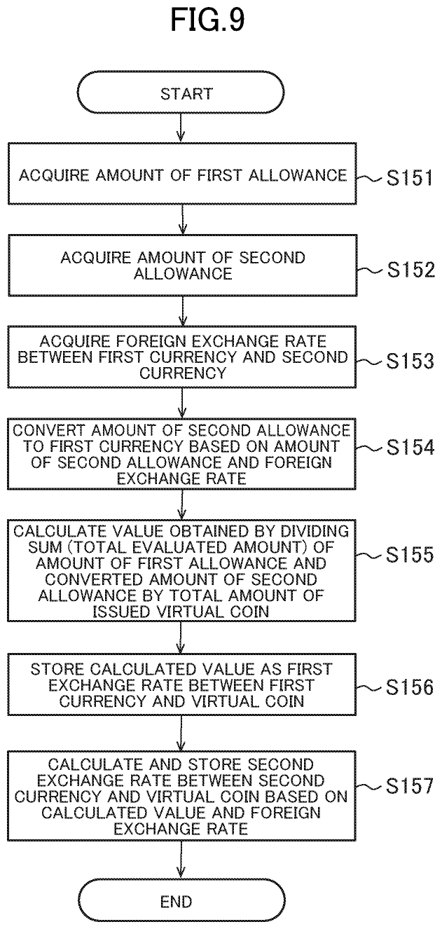

Next, description is made of processing of calculating the first exchange rate and the second exchange rate. FIG. 9 is a flow chart for illustrating an example of processing of calculating the exchange rate.

First, the first money evaluating unit 53 acquires the amount of first allowance at the current time point as the first evaluated monetary amount (Step S151). The second money evaluating unit 57 acquires the amount of second allowance at the current time point as the second evaluated monetary amount (Step S152). The amount of first allowance is an amount based on the first currency, and the amount of second allowance is an amount based on the second currency. The converter unit 62 acquires the foreign exchange rate between the first currency and the second currency from an external system configured to manage or disclose the current foreign exchange rate, namely, the foreign exchange information server 6 (Step S153).

The converter unit 62 converts the amount of second allowance of the second currency to the first currency based on the acquired amount of second allowance and foreign exchange rate (Step S154). Then, the total evaluating unit 63 calculates a value obtained by dividing a sum (total evaluated amount) of the amount of first allowance and the converted amount of second allowance by the total amount of issued virtual coin (Step S155). Then, the total evaluating unit 63 stores the calculated value into the storage 12 as the first exchange rate between the first currency and the virtual coin (Step S156).

The processing of Step S154 and Step S155 is represented by a mathematical expression below.

$$R C 1 = \frac{A 1 + A 2 \times {E}_{12}}{T C}$$

In the expression given above, RC1 represents an exchange rate between the first currency and the virtual coin, A1 represents the amount of first allowance based on the first currency, A2 represents the amount of second allowance of the second currency, and TC represents a total amount of issued virtual coin. E₁₂ represents the foreign exchange rate between the first currency and the second currency, and the amount of the second currency can be multiplied by E₁₂ for conversion to the first currency.

When the number of types of currency that can be exchanged with the virtual coin is 3 or more (n represents number of types of currency, and satisfies 3≤k≤n), the converter unit 62 acquires a foreign exchange rate between the first currency and the k-th currency from the foreign exchange information server 6, and converts the amount of k-th allowance to the first currency based on the foreign exchange rate and the amount of k-th allowance. Further, the total evaluating unit 63 calculates, as the first exchange rate, a value obtained by dividing a sum (total evaluated value) of the amount of first allowance to the amount of n-th allowance by the total amount of issued virtual coin.

The order of calculation is not limited to the above-mentioned order. For example, the exchange rate may be calculated by dividing the total amount of virtual coin by the total evaluated amount in Step S155. Further, as shown in the following expression, the total evaluating unit 63 may calculate, as the exchange rate, a sum of a value obtained by dividing the amount of first allowance by the total amount of issued virtual coin and a value obtained by dividing the amount of second allowance by the total amount of issued virtual coin.

$$R C 1 = \frac{A 1}{TC} + \frac{A 2}{TC} \times {E}_{12}$$

When the first exchange rate is calculated, the total evaluating unit 63 further calculates the second exchange rate between the second currency and the virtual coin based on the calculated value (first exchange rate) and the foreign exchange rate, and stores the second exchange rate into the storage 12 (Step S157). An expression for calculating the second exchange rate based on the first exchange rate by using the foreign exchange rate E12 is given below.

$$R C 2 = \frac{R C 1}{{E}_{12}}$$

RC2 represents the second exchange rate. The exchange rate is calculated by a similar expression also when the number of types of currency is three or more. Further, division and multiplication may be exchanged with each other in an expression relating to the foreign exchange rate depending on the definition of the foreign exchange rate.

An exchange rate for each of the second currency and the k-th currency (k is 3 or more and n or less) can also be calculated by a method similar to that for the first currency. A generalized expression of calculating an exchange rate RCi for j-th currency (i is an integer of 1 or more and n or less) is given below.

$$R C i = \frac{{Σ}_{j} Aj \times Eij}{T C}$$

Aj represents an amount of j-th allowance based on j-th currency (j is an integer of 1 or more and n or less). Dᵢⱼ represents a foreign exchange rate between i-th currency and the j-th currency. The amount of j-th currency can be multiplied by Eᵢⱼ for conversion to the i-th currency, and Eii is set to be 1.

In this embodiment, the exchange rate between the currency and the virtual coin is determined based on an allowance of currency exchanged for the virtual coin so far. In general, virtual currency, the exchange rate is determined only based on demand and supply, and thus the exchange rate greatly changes due to demand and supply at that time. However, in this embodiment, the exchange rate does not change when the foreign exchange rate does not change, and thus change in exchange rate is suppressed considerably.

Further, the foreign exchange rate is used rationally for calculation of the exchange rate, and thus, for example, restriction of allowing the virtual coin to be exchanged for only one currency is not required. Further, contrary to the foreign exchange market, a system of providing an independent exchange shop for each of a plurality of types of currency, and adjusting inconsistency with the foreign exchange market through exchange transaction by a third party is also not required. Therefore, the virtual coin in this embodiment achieves international usage more easily. As a result, this embodiment provides an electronic value that achieves both of international usage and prevention of drastic fluctuation of the exchange rate.

With the virtual coin using the above-mentioned exchange rate, the system configuration can be optimized and simplified more. As a result, the processing load is reduced.

It is assumed that a system of providing an electronic value relating to currency of the country is installed in each of a plurality of countries, and further, a user of one country uses an electronic value associated with currency of that country for payment to a system of another country. In this case, the simplest method for enabling an electronic value of one user to be used for payment in another country requires connection among systems of the plurality of countries. When the number of countries is set to N, the number of connections is N×(N−1)/2. When the number of countries increases, the number of connections greatly increases, with the result that the system becomes more complex.

In contrast, it is also considered that a key currency serving as a central role of payment is provided, and a central system, which is arranged in a country handling the key currency, and a system of another country are connected to each other. The number of connections in this case is (N−1). In this case, on the side of the system of another country, an electronic value associated with currency of that country is exchanged for the key currency in the foreign exchange market. Then, when an electronic value is used in another country, the electronic value is always exchanged for the key currency, and thus the amount of processing for foreign exchange increases. Further, once the central system is set, it becomes extremely difficult for the central system to be transferred to another country.

As another method, it is also considered not to provide the key currency while at the same time connecting the system of one country being the central system to the system of another country. In this case, the central system is required to handle all the types of currency, and thus the central system has a large processing load, and it is difficult to increase the scale.

In this embodiment, an exchange rate between different types of currency of respective countries is calculated repeatedly, but exchange of monetary values in the foreign exchange market is not required. Thus, it is easy to arrange the virtual currency management system 1 in one country (or region) to receive connection from systems installed in various countries. At that time, it is possible to reduce the problem of performance while at the same time simplifying the system configuration.

The system configuration and performance have advantages compared to general virtual currency. Calculation of the exchange rate in this embodiment is easy, and it is also easy to calculate an amount of exchange of a virtual coin for actual currency or vice versa. In the case of general virtual currency (crypt asset), when actual currency and virtual currency are exchanged for each other, a market system implementing the market determines an exchange rate, and the actual currency and the virtual currency are exchanged for each other. In this case, the market system executes in real time complex processing of acquiring a plurality of requests for exchanging the virtual currency for the actual currency, and a plurality of requests for exchanging the actual currency for the virtual currency, causing the exchange rate to change depending on those requests, and establishing a transaction when the amount of virtual currency matches substantially. This processing requires internal management of a large number of requests in parallel, and thus a large number of memories or a large amount of processing is required.

In this embodiment, the exchange rate between the virtual coin and the actual currency is calculated based on pieces of information easily managed within a system or easily acquired from the outside, such as the foreign exchange rate, the total amount of virtual coin, the amount of first allowance, and the amount of second allowance, and there is no need to manage a plurality of exchanges in parallel. As a result, the processing of calculating the exchange rate by the virtual currency management system 1, and the processing of exchanging the virtual coin for the actual currency are simplified, to thereby reduce the processing load.

In this embodiment, as in the case of loyalty points in a commercial transaction, description has been made of an example of providing the user with a virtual coin at a proportion determined in accordance with a purchase amount when the user has purchased a product. However, it is also possible to provide the user with a virtual coin in other cases. For example, it is also possible to separately provide a virtual coin equivalent to the related-art loyalty points together with those loyalty points, or sell a virtual coin by exchanging the virtual coin for legal tender. Alternatively, the user may be provided with a virtual coin free of charge when a condition of a predetermined campaign is satisfied. Alternatively, for example, a virtual coin may be provided to, for example, a virtual currency exchange shop operated by a third party, and users may settle a transaction therebetween in the virtual currency exchange shop.

Further, in the above-mentioned example, virtual coin ownership information stored in the storage 12 of the virtual currency management system 1 can be issued based on a distributed ledger in a so-called distributed public blockchain platform, which manages the owner or distribution, or can be managed by a private blockchain platform. Alternatively, distribution of an electronic value may be managed not by a distributed ledger in a blockchain platform but by a centralized management server.

The electronic value may be loyalty points usable among countries using different types of currency. When the present invention is applied to loyalty points, loyalty point information has data structure in which the virtual coin ID is deleted from the virtual coin ownership information shown in FIG. 10. Now, description is made of processing involving using loyalty points.

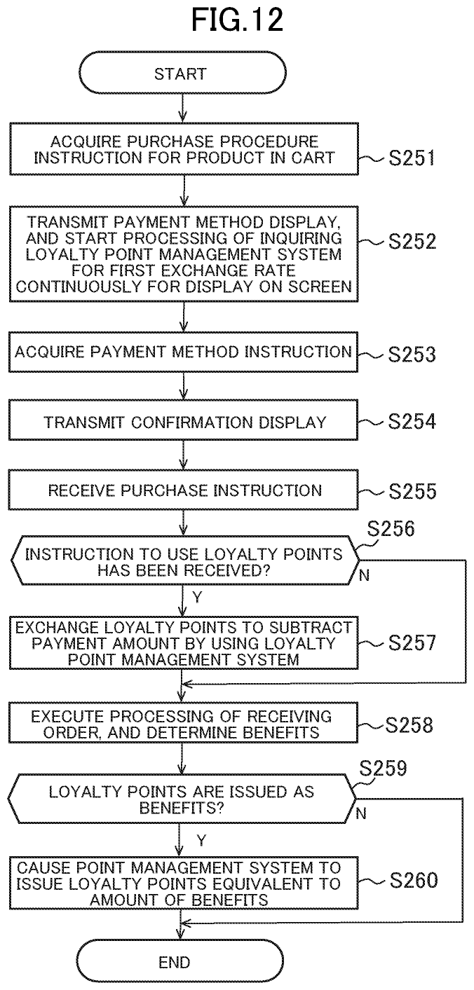

FIG. 12 is a flow chart for illustrating an example of processing to be executed by the electronic commerce system 2, and a flow chart corresponding to FIG. 5. FIG. 12 is an illustration of processing since a purchase procedure instruction relating to an order is received from the customer terminal 3 and reception of the order is executed after that until a loyalty point is issued as required. The processing illustrated in FIG. 12 is executed by the processor 11 included in the electronic commerce system 2 executing a program stored in the storage 12 to control the communication unit 13, for example. In the following, description is mainly made of a difference from FIG. 5. In this case, a loyalty point management system configured to exchange loyalty points for actual currency is provided instead of the virtual currency management system 1.

First, the processor 11 included in the electronic commerce system 2 acquires a purchase procedure instruction, which has been received by the communication unit 13 (Step S251). Then, the processor 11 causes the communication unit 13 to transmit payment method display to the customer terminal 3, and starts to execute exchange rate update processing (Step S252). The exchange rate update processing is processing of transmitting, to the customer terminal 3, the latest first exchange rate acquired by inquiring the loyalty point management system for the first exchange rate periodically and continuously, and displaying the latest first exchange rate on the screen of the customer terminal 3.

Then, the processor 11 acquires the payment method instruction, which has been received by the communication unit 13 from the customer terminal 3 (Step S253). Then, the processor 11 causes the communication unit 13 to transmit confirmation display to the customer terminal 3 (Step S254). After that, the processor 11 acquires the purchase instruction received by the communication unit 13 from the customer terminal 3 (Step S255).

When the purchase instruction is acquired, the processor 11 checks whether an instruction to use loyalty points has been received together with the purchase instruction (Step S256). When the instruction to use loyalty points has been received (Y in Step S256), the processor 11 causes the communication unit 13 to transmit a currency provision request to the loyalty point management system, acquires payment information, exchanges the loyalty points for the first currency, and uses the first currency obtained through exchange for payment by the customer (Step S257). Alternatively, when the instruction to use loyalty points has not been received (N in Step S256), the processing of Step S257 is skipped.

Further, the processor 11 executes payment processing and processing of receiving an order based on, for example, the payment method included in the confirmation display, and determines benefits to be provided to the customer operating the customer terminal 3 for that order (Step S208).

Then, when it is determined that loyalty points are issued to the customer as benefits (Y in Step S259), the processor 11 causes the communication unit 13 to transmit a point issuance request to the loyalty point management system, and causes the loyalty point management system to issue loyalty points equivalent to the monetary amount of benefits (Step S260). When it is determined that loyalty points are not issued to the customer as benefits (N in Step S259), the processing of Step S260 is skipped.

The loyalty point management system executes processing similar to those of FIG. 7, FIG. 8, and FIG. 9. More specifically, such similar processing has the following difference in addition to replacement of the virtual coin with loyalty points. Instead of issuing and transmitting the virtual coin in Step S114, processing of increasing the balance of loyalty points of the user in loyalty point information by a recorded amount of exchanged loyalty points is executed. Instead of returning the virtual coin in Step S134, processing of decreasing the balance of loyalty points of the user in loyalty point information by an amount of exchanged loyalty points is executed.

In this manner, also in the case of loyalty points, with processing similar to that of the virtual coin, it is possible to provide an electronic value having a characteristic of enabling international usage with a smaller processing load.

Further, in this embodiment, description has been made of an example in which the virtual coin is transferred depending on sale and purchase in the electronic commerce system 2. However, the virtual coin may be transferred between individuals. In this case, it is considered that the monetary value of a virtual coin per unit changes due to a free demand/supply balance between users, but the value of a virtual coin at the time of using the virtual coin in sale and purchase in the electronic commerce system 2 is determined as described above. Thus, the monetary value of the virtual coin in the market is expected to converge to a vicinity of the monetary value calculated in this embodiment.

### REFERENCE SIGNS LIST

1 virtual currency management system, 2, 4 electronic commerce system, 3, 5 customer terminal, 11 processor, 12 storage, 13 communication unit, 14 input/output unit, 51 first exchange unit, 52 first allowance managing unit, 53 first money evaluating unit, 55 second exchange unit, 56 second allowance managing unit, 57 second money evaluating unit, 59 issuing unit, 61 rate managing unit, 62 converter unit, 63 total evaluating unit, 64 rate calculating unit, 81 first exchange rate, 82 converted amount.

What is claimed is:

1. An electronic value management system, comprising:
first acquisition means for acquiring a first evaluated monetary amount based on a first currency, which is evaluated for a currently distributed electronic value issued for the first currency;
second acquisition means for acquiring a second evaluated monetary amount based on a second currency, which is evaluated for a currently distributed electronic value issued for the second currency; and
rate calculation means for calculating an exchange rate between the first currency and the electronic value based on the first evaluated monetary amount, the second evaluated monetary amount, a foreign exchange rate between the first currency and the second currency, and a total amount of the currently distributed electronic value.

2. The electronic value management system according to claim 1, further comprising conversion means for converting the second evaluated monetary amount to the first currency based on the foreign exchange rate between the first currency and the second currency,
wherein the rate calculation means is configured to calculate the exchange rate between the first currency and the electronic value based on the first evaluated monetary amount, the converted second evaluated monetary amount, and the total amount of currently distributed electronic value.

3. The electronic value management system according to claim 2, further comprising total evaluation means for calculating a total evaluated monetary amount based on the first evaluated monetary amount and the converted second evaluated monetary amount,
wherein the rate calculation means is configured to calculate the exchange rate between the first currency and the electronic value by dividing the total evaluated monetary amount by the total amount of currently distributed electronic value.

4. The electronic value management system according to claim 1,
wherein the first evaluated monetary amount is an allowance saved by the first currency depending on an electronic value issued for the first currency, and
wherein the second evaluated monetary amount is an allowance saved by the second currency depending on an electronic value issued for the second currency.

5. The electronic value management system according to claim 1, further comprising first currency exchange means for exchanging, based on the calculated exchange rate, an electronic value having a given recorded amount for the first currency having a currency amount equivalent to the electronic value.

6. The electronic value management system according to claim 1, further comprising second currency exchange means for exchanging, based on the calculated exchange rate, an electronic value having a given recorded amount for the second currency having a currency amount equivalent to the electronic value.

7. The electronic value management system according to claim 4, further comprising:
first currency exchange means for providing, for the first currency having a given first currency amount, an electronic value having a first recorded amount that depends on the given first currency amount and the exchange rate, and providing, for an electronic value having a given second recorded amount, the first currency having a second currency amount that depends on the given second recorded amount and the exchange rate;
second currency exchange means for providing, for the second currency having a given third currency amount, an electronic value having a third recorded amount that depends on the given third currency amount and the exchange rate, and providing, for an electronic value having a given fourth recorded amount, the second currency having a fourth currency amount that depends on the given fourth recorded amount and the exchange rate;
first allowance management means for adding, when the electronic value is provided for the first currency, a value equivalent to the given first currency amount to a first allowance being an allowance based on the first currency, and subtracting, when the first currency is provided for the electronic value, a value equivalent to the second currency amount from the first allowance; and
second allowance management means for adding, when the electronic value is provided for the second currency, a value equivalent to the given third currency amount to a second allowance being an allowance based on the second currency, and subtracting, when the second currency is provided for the electronic value, a value equivalent to the fourth currency amount from the second allowance.

8. An electronic value management method, comprising:
acquiring a first evaluated monetary amount based on a first currency, which is evaluated for a currently distributed electronic value issued for the first currency;
acquiring a second evaluated monetary amount based on a second currency, which is evaluated for a currently distributed electronic value issued for the second currency; and
calculating an exchange rate between the first currency and the electronic value based on the first evaluated monetary amount, the second evaluated monetary amount, a foreign exchange rate between the first currency and the second currency, and a total amount of the currently distributed electronic value.

9. A non-transitory computer readable storage medium storing a plurality of instructions, wherein when executed by at least one processor, the plurality of instructions cause a computer to function as:
first acquisition means for acquiring a first evaluated monetary amount based on a first currency, which is evaluated for a currently distributed electronic value issued for the first currency;
second acquisition means for acquiring a second evaluated monetary amount based on a second currency, which is evaluated for a currently distributed electronic value issued for the second currency; and
rate calculation means for calculating an exchange rate between the first currency and the electronic value based on the first evaluated monetary amount, the second evaluated monetary amount, a foreign exchange rate between the first currency and the second currency, and a total amount of the currently distributed electronic value.
